(19) United States
(12) Patent Application Publication
(10) Pub. No.: US 2010/0127612 A1
(43) Pub. Date: May 27, 2010

(54) PHOSPHOR AND ELECTRON BEAM EXCITED LIGHT-EMITTING DEVICE

(76) Inventors: Yoshiko Nakamura, Tokyo (JP); Toshinori Isobe, Ibaraki (JP); Satoru Kuze, Ibaraki (JP); Susumu Miyazaki, Ibaraki (JP)

Correspondence Address: SUGHRUE MION, PLLC, 2100 PENNSYLVANIA AVENUE, N.W., SUITE 800, WASHINGTON, DC, 20037, US

(21) Appl. No.: 11/909,090

(22) PCT Filed: Mar. 20, 2006
(86) PCT No.: PCT/JP06/06059

§ 371 Date: Sep. 19, 2007

(30) Foreign Application Priority Data
Mar. 24, 2005 (JP) 2005-085668

(51) Int. Cl. H01J 1/62; C09K 11/77; C09K 11/54; C09K 11/08; C09K 11/59; C09K 11/55

(52) U.S. Cl. 313/495; 252/301.4 R; 252/301.6 R; 252/301.6 F; 252/301.4 F; 313/483

(57) ABSTRACT

The present invention provides a phosphor and an electron beam excited light-emitting device. The phosphor comprises a compound represented by the formula (I) ; and at least one selected from the group consisting of Ce, Pr, Nd, Pm, Sm, Eu, Gd, Tb, Dy, Ho, Er, Tm, Yb and Mn as an activator,

M¹O.mM²O.nM³O₂ (I)

wherein M¹ is at least two selected from the group consisting of Ca, Sr and Ba, Sr alone or Ba alone, M² is at least one selected from the group consisting of Mg and Zn, M³ is at least one selected from the group consisting of Si, Ge and Zr, 0.8≦m≦1.2, and 1.6≦n≦2.4. The electron beam excited light-emitting device comprises the above phosphor.

### TECHNICAL FIELD

The present invention relates to a phosphor and an electron beam excited light-emitting device.

### BACKGROUND ART

In recent years, a field emission display (FED) and a surface-conduction electron-emitter display (SED) have been attracting attention and developed as light emitting devices. These light emitting devices include a phosphor and an electron beam excitation source for exciting the phosphor to emit light. For example, CaMgSi₂O₆: Eu is known as a phosphor for emitting light under electron beam irradiation. (Extended Abstract of the Fifth International Conference on the Science and Technology of Display Phosphors, 1999, p. 317-P. 320).

However, in view of performance improvement of light emitting devices, a phosphor with high brightness is required.

### DISCLOSURE OF THE INVENTION

An object of the present invention is to provide a phosphor that exhibits high brightness under electron beam irradiation, and an electron beam excited light-emitting device using such a phosphor.

The present inventors have conducted diligent studies on phosphors, and have accomplished the present invention.

The present invention provides a phosphor comprising a compound represented by the formula (I)

M¹O.mM²O.nM³O₂ (I)

and at least one selected from the group consisting of Ce, Pr, Nd, Pm, Sm, Eu, Gd, Tb, Dy, Ho, Er, Tm, Yb and Mn as an activator, wherein M¹ is at least two selected from the group consisting of Ca, Sr and Ba; Sr alone; or Ba alone,

M² is at least one selected from the group consisting of Mg and Zn,

M³ is at least one selected from the group consisting of Si, Ge and Zr,

m is not less than 0.8 and not more than 1.2, and

n is not less than 1.6 and not more than 2.4.

Moreover, the present invention provides an electron beam excited light-emitting device comprising the above-mentioned phosphor and an electron emitter.

### MODE FOR CARRYING OUT THE INVENTION

### Phosphor

A phosphor of the present invention includes a compound represented by the above formula (I) and an activator. In the formula (I), M¹ is a divalent metal element such as calcium (Ca), strontium (Sr) and barium (Ba), and is any one of Sr and Ba; combination of Ca and Sr; combination of Ca and Ba; combination of Sr and Ba; and combination of Ca, Sr and Ba.

M² is a divalent metal element such as magnesium (Mg) and zinc (Zn), and is any one of Mg and Zn; and combination of Mg and Zn, preferably Mg; and combination of Mg and Zn, more preferably Mg.

M³ is a tetravalent metal element such as silicon (Si), germanium (Ge) and zirconium (Zr), and is any one of Si, Ge and Zr; combination of Si and Ge; combination of Si and Zr; combination of Ge and Zr; and combination of Si, Ge and Zr, preferably Si, combination of Si and Ge; combination of Si and Zr; and combination of Si, Ge and Zr, and more preferably Si.

In the formula (I), m is not less than 0.8 and not more than 1.2. n is not less than 1.6 and not more than 2.4. The activator is cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) or manganese (Mn), preferably Eu. These elements may be used either alone or in combination as the activator.

The phosphor may further include other metal element such as monovalent metal element or trivalent metal element. Examples of such metal element include lithium (Li), sodium (Na), potassium (K), rubidium (Rb), iron (Fe), indium (In), lanthanum (La), lutetium (Lu), bismuth (Bi) and antimony (Sb). These elements may be used alone or in combination.

The phosphor preferably includes a compound represented by the formula (II).

(M¹₁₋ₐEuₐ) M²M³₂O₆ (II)

In the formula (II), M¹, M² and M³ are similar to M¹, M² and M³ in the above formula (I), respectively, a is more than 0, preferably not less than 0.003, and less than 0.3, preferably not more than 0.2.

The phosphor more preferably includes a compound represented by the formula (III).

Ca_{1-b-c}Sr_{b}Eu_{c}MgSi₂O₆ (III)

b is more than 0.7, preferably not less than 0.75, more preferably not less than 0.8, and less than 1, preferably not more than 0.98. c is more than 0, preferably not less than 0.003, and less than 0.3, preferably not more than 0.2. The total of b and c is more than 0.7 and not more than 1.

Moreover, the phosphor preferably has the same crystal structure as diopside (malacolite).

The phosphor satisfies the above composition, and is excited to emit visible light under electron beam irradiation. Examples of the phosphor include compounds represented by Sr_{0.98}Eu^{0.02}MgSi₂O₆; Sr_{0.72}Eu^{0.28}MgSi₂O₆; Ba_{0.98}Eu_{0.02}MgSi₂O₆; Ba_{0.72}Eu_{0.28}MgSi₂O₆; Ca_{0.25}Sr_{0.72}Eu_{0.02}MgSi₂O₆; and Ca_{0.08}Sr_{0.72}Eu_{0.2}MgSi₂O₆. Examples of an electron beam, serving as an excitation source for the phosphor, include low velocity electron beam (acceleration voltage: about 0.001 kV to about 10 kV), and high velocity electron beam (acceleration voltage: about 20 kV to about 30 kV), preferably low velocity electron beam. Therefore, the phosphor is used for an electron beam excited light-emitting device such as FED and SED whose excitation source is a low velocity electron beam, or an electron beam excited light-emitting device such as CRT and VFD whose excitation source is a high velocity electron beam, and is preferably used for an FED or SED.

The phosphor of the present invention may be produced by calcining a mixture of metal compounds, which is converted into a phosphor including the compound represented by the formula (I) and the above activator by calcination; for example, the metal compounds may be weighed to obtain the mixture satisfying the molar ratio of the metal elements within the phosphor, and the mixture may subsequently be calcined.

The metal compounds are compounds of calcium, strontium, barium, magnesium, zinc, silicon, germanium, zirconium, cerium, praseodymium, neodymium, promethium, samarium, europium, gadolinium, terbium, dysprosium, holmium, erbium, thulium, ytterbium, and manganese; for example, the metal compound may be oxide, or compound such as hydroxide, carbonate, nitrate, halide and oxalate which is decomposed or converted into oxide at a high temperature. Instead of adding halide as a flux as described later, metal halide, preferably metal fluoride or metal chloride may be used as the metal compound.

The phosphor including the compound represented by Sr_{0.98}Eu_{0.02}MgSi₂O₆ is produced by weighing SrCO₃, Eu₂O₃, MgO and SiO₂ so as to obtain a mixture in which the molar ratio of Sr:Eu:Mg:Si is 0.98:0.02:1:2 and calcining the mixture. The phosphor including the compound represented by Ba_{0.98}Eu_{0.02}MgSi₂O₆ is produced by weighing BaCO₃, Eu₂O₃, MgO and SiO₂ so as to obtain a mixture in which the molar ratio of Ba:Eu:Mg:Si is 0.98:0.02:1:2 and calcining the mixture. furthermore, the phosphor including the compound represented by Ca_{0.26}Sr_{0.72}Eu_{0.02}MgSi₂O₆ is produced by weighing CaCO₃, SrCO₃, Eu₂O₃, MgO and SiO₂ so as to obtain a mixture in which the molar ratio of Ca:Sr:Eu:Mg:Si is 0.26:0.72:0.02:1:2 and calcining the mixture.

The mixing may be carried out using an apparatus such as ball mill, V-shaped mixer and agitator. When a mixture of the metal compounds contains metal hydroxide, metal carbonate, metal nitrate, metal halide or metal oxalate, which is decomposed or oxidized at a high temperature to become oxide, the mixture may be pre-calcined prior to calcination. The pre-calcination may be carried out at a temperature of not less than about 400° C. and less than about 1000° C. The pre-calcined mixture may be pulverized.

For example, the calcination may be carried out under the following conditions of

temperature: not less than about 1000° C., preferably about not less than 1100° C., and not more than about 1500° C., preferably not more than about 1200° C.;

retention time: not less than 0.3 hours and not more than 100 hours, and

atmosphere: reduction gas such as nitrogen containing 0.1 to 10% by volume of hydrogen, and argon containing 0.1 to 10% by volume of hydrogen.

In the method of the present invention, carbon may be added to a mixture of the metal compounds prior to the calcination. Due to the addition of carbon, the calcination is carried out under a stronger reduction atmosphere. Furthermore, flux may be added to a mixture of the metal compounds prior to the calcination. Due to the addition of flux, a phosphor having a high crystallity or a large average particle diameter is obtained. Examples of the flux include LiF, NaF, KF, LiCl, NaCl, KCl, Li₂CO₃, Na₂CO₃, K₂CO₃, NaHCO₃, NH₄Cl, and NH₄I. The calcination may usually be carried out once, but may alternatively be carried out twice or more.

The phosphor may be pulverized, washed or classified. The pulverization and/or classification may be carried out using an apparatus capable of adjusting the particle size of the phosphor, and the pulverization may be carried out using ball mill or jet mill. The classification may be carried out using sieve or cyclone.

### Electron Beam Excited Light-Emitting Device

An electron beam excited light-emitting device of the present invention includes the above phosphor, and usually includes the phosphor and an electron emitter. The electron emitter emits an electron beam for exciting the phosphor to emit light. Examples of the electron emitter include electron gun and flat electron emitter.

Examples of the electron beam excited light-emitting device include FED, SED, CRT, and VFD, preferably FED and SED.

As disclosed in JP 2002-138279, the FED may be manufactured by a method including the steps of (i)-(iv):

(i) preparing respective liquids for a blue phosphor, a green phosphor and a red phosphor by dispersing each phosphor in a solvent (for example, a polyvinyl alcohol solution);

(ii) applying the respective liquids onto a glass substrate and drying the liquids to form the respective phosphor layers, to obtain a face plate;

(iii) supporting the face plate and the rear plate formed with several electron emitters using support members;

(iv) evacuating and sealing a space between the face plate and the rear plate.

The blue phosphor is a phosphor including the compound represented by the formula (I) and the above activator, and other blue phosphor may be used in combination. Example of the other blue phosphor include zinc sulfide phosphor (ZnS: Ag, Cu, Au, Al). Example of the green phosphor include zinc sulfide phosphor (ZnS: Cu, Au, Al). Examples of the red phosphor include yttrium oxide phosphor (Y₂O₃: Eu) and yttrium sulfide phosphor (Y₂O₂S: Eu).

The SED may be manufactured similarly to the FED, and may be manufactured by the method disclosed in paragraph 0182 to 0189 of JP 2002-83537, for example (bonding a substrate with a plurality of surface conduction electron emitters on a rear plate, supporting the face plate consisting of a glass substrate and a phosphor layer and a metal back which are formed on inner face of the glass substrate, with the substrate using support members, applying frit glass to their junctions and calcining in air so as to be sealed, and evacuating and sealing a space.). When monochrome display is carried out, the phosphor including the compound represented by the formula (I) and the above activator is used to apply to spaces therebetween to obtain phosphor layer. When color display is carried out, a black stripe or black matrix is formed and phosphors of respective colors including the above phosphor are applied to spaces therebetween to obtain phosphor layers.

Furthermore, the CRT and VFD may each be manufactured according to known methods except that the above phosphor is used.

### EXAMPLES

The following examples will illustrate the present invention in more detail, but do not limit the scope of the invention.

A brightness was determined by irradiating a phosphor with an electron beam having an acceleration voltage of 10 kV and a cross-sectional area of 1 μA/cm². The chromaticity coordinates (x, y) were determined in accordance with XYZ colorimetric system, i.e., CIE standard colorimetric system defined by CIE (Commission Internationale de l'Eclairage).

### REFERENCE 1

Calcium carbonate (CaCO₃, manufactured by Ube Material Industries, Ltd., trade name: “ultrapure calcium carbonate CS.3N-A”), europium oxide (Eu₂O₃, manufactured by Shin-Etsu Chemical Co., Ltd.), magnesium carbonate (MgO content: 42.0%, manufactured by Kyowa Chemical Industry Co., Ltd., trade name: “ultrapure magnesium carbonate”), and silicon dioxide (SiO₂, manufactured by Nippon Aerosil Co., Ltd., trade name: “AEROSIL200”) were weighed and mixed to obtain a mixture in which the molar ratio of Ca:Eu:Mg:Si was 0.992:0.008:1:2, and the mixture was calcined at 1220° C. for 2 hours under an N₂ atmosphere containing 2% by weight of H₂. The calcination was carried out three times in total to obtain phosphor 1 including a compound represented by the formula of Ca_{0.992}Eu_{0.008}MgSi₂O₆.

The phosphor 1 emitted blue light under electron beam irradiation. The brightness and chromaticity coordinates (x, y) were shown in Table 1. In the EXAMPLE, the brightness of the phosphor 1 was defined as 100. The crystal structure of the phosphor 1 was determined using an X-ray diffractometer. The phosphor 1 had the same crystal structure as diopside.

### Example 1

Strontium carbonate (SrCO₃, manufactured by Sakai Chemical

Industry Co., Ltd., trade name: “ultrapure strontium carbonate SW-K”), europium oxide (Eu₂O₃, manufactured by Shin-Etsu Chemical Co., Ltd.), magnesium carbonate (MgO content: 42.0%, manufactured by Kyowa Chemical Industry Co., Ltd., trade name: “ultrapure magnesium carbonate”), and silicon dioxide (SiO₂, manufactured by Nippon Aerosil Co., Ltd., trade name: “AEROSIL 200”) were weighed and mixed to obtain a mixture in which the molar ratio of Sr:Eu:Mg:Si was 0.98:0.02:1:2. The mixture was calcined at 1150° C. for 2 hours under an N₂ atmosphere containing 2% by volume of H₂. The calcination was carried out three times in total to obtain phosphor 2 including a compound represented by the formula of Sr_{0.98}Eu_{0.02}MgSi₂O₆.

The phosphor 2 emitted blue light under electron beam irradiation. The brightness and chromaticity coordinates (x, y) were shown in Table 1. The phosphor 2 had the same crystal structure as diopside.

TABLE 1
Phosphor Composition and Emission Property

| | | | | Chromaticity | |
|---|---|---|---|---|---|
| | | | | coordinates | |
| | | Composition | Brightness | x | Y |
| Ref. 1 | Phosphor 1 | Ca_{0.992}Eu_{0.008}MgSi₂O₆ | 100 | 0.155 | 0.045 |
| Ex. 1 | Phosphor 2 | Sr_{0.98}Eu_{0.02}MgSi₂O₆ | 112 | 0.158 | 0.035 |

### INDUSTRIAL APPLICABILITY

The phosphor of the present invention is excited to emit light with high brightness under electron beam irradiation. The phosphor is suitably used for an electron beam excited light-emitting device such as FED and SED.

1. A phosphor comprising a compound represented by the formula (I)
M¹O.mM²O.nM³O₂ (I)
and at least one selected from the group consisting of Ce, Pr, Nd, Pm, Sm, Eu, Gd, Tb, Dy, Ho, Er, Tm, Yb and Mn as an activator, wherein M¹ is at least two selected from the group consisting of Ca, Sr and Ba, Sr alone or Ba alone,
M² is at least one selected from the group consisting of Mg and Zn,
M³ is at least one selected from the group consisting of Si, Ge and Zr,
0.8≦m≦1.2, and
1.6≦n≦2.4.

2. The phosphor according to claim 1, comprising a compound represented by the formula (II),
(M¹₁₋ₐEuₐ) M²M³₂O₆ (II)
wherein M¹, M² and M³ are similar to M¹, M² and M³ in the formula (I), respectively, and
0<a<0.3.

3. The phosphor according to claim 1, comprising a compound represented by the formula (III),
Ca_{1-b-c}Sr_{b}Eu_{c}MgSi₂O₆ (III)
wherein 0.7<b<1,
0<c<0.3, and
0.7<b+c≦1.

4. The phosphor according to claim 1, wherein the phosphor has the same crystal structure as diopside.

5. An electron beam excited light-emitting device comprising the phosphor according to any one of claims 1 to 4.

6. The electron beam excited light-emitting device according to claim 5, wherein the electron beam excited light-emitting device further comprises an electron emitter.

7. The electron beam excited light-emitting device according to claim 5, wherein the electron beam excited light-emitting device is selected from FED, SED, CRT and VFD.

8. The electron beam excited light-emitting device according to claim 7, wherein the electron beam excited light-emitting device is selected from FED and SED.

9. A use of the phosphor according to any one of claims 1 to 4 for an electron beam excited light-emitting device.
